(19) United States
(12) Patent Application Publication
(10) Pub. No.: US 2025/0266950 A1
(43) Pub. Date: Aug. 21, 2025

(54) SINGLE TRIGGER FRAME USE FOR TRIGGER BASED RANGING SOUNDING MODES

(71) Applicant: QUALCOMM Incorporated, San Diego, CA (US)

(72) Inventors: Sanjhi GUPTA, Jaipur (IN); Parthiban ELLAPPAN, Virudhunagar(Dist) (IN); Xiaoxin ZHANG, Sunnyvale, CA (US); Jitesh Kumar GUPTA, Lucknow (IN); Alireza RAISSINIA, Monte Sereno, CA (US)

(21) Appl. No.: 18/444,240

(22) Filed: Feb. 16, 2024

(51) Int. Cl. H04L 5/00; H04W 56/00

(52) U.S. Cl. CPC H04L 5/0048; H04W 56/0065

(57) ABSTRACT

This disclosure provides methods, components, devices and systems for single trigger frame use for trigger based ranging sounding modes. Some aspects more specifically relate to trigger-based ranging (TBR) multi-user (MU) sounding. In some examples, a responding wireless device (such as a responding wireless station (RSTA)) may transmit a sounding signal during a sounding phase of a sounding procedure. The sounding signal may include multiple user fields, with each user field corresponding to an initiating wireless device (such as an initiating wireless station (ISTA)). The user field may indicate a timing offset for the ISTA that identifies a response window for the ISTA. The RSTA may receive a response signal from each ISTA during the response window. For example, the RSTA may receive a response signal from each ISTA during the response window identified by the timing offset.

### TECHNICAL FIELD

This disclosure relates generally to wireless communication and, more specifically, to single trigger frame use for trigger based ranging sounding modes.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

### SUMMARY

The systems, methods, and devices of this disclosure each have several innovative aspects, no single one of which is solely responsible for the desirable attributes disclosed herein.

A method for wireless communications by a responding wireless device is described. The method may include transmitting a sounding signal during a sounding phase of a sounding procedure, the sounding signal indicating multiple user fields, each user field identifying a timing offset for each initiating wireless device of multiple initiating wireless devices, where the timing offset identifies a response window associated with each initiating wireless device within the sounding phase and receiving a response signal from each initiating wireless device during the sounding phase, each response signal received in the response window according to the timing offset of each initiating wireless device.

A responding wireless device for wireless communications is described. The responding wireless device may include a processing system that includes processor circuitry and memory circuitry that stores code. The processing system may be configured to cause the responding wireless device to transmit a sounding signal during a sounding phase of a sounding procedure, the sounding signal indicating multiple user fields, each user field identifying a timing offset for each initiating wireless device of multiple initiating wireless devices, where the timing offset identifies a response window associated with each initiating wireless device within the sounding phase and receive a response signal from each initiating wireless device during the sounding phase, each response signal received in the response window according to the timing offset of each initiating wireless device.

Another responding wireless device for wireless communications is described. The responding wireless device may include means for transmitting a sounding signal during a sounding phase of a sounding procedure, the sounding signal indicating multiple user fields, each user field identifying a timing offset for each initiating wireless device of multiple initiating wireless devices, where the timing offset identifies a response window associated with each initiating wireless device within the sounding phase and means for receiving a response signal from each initiating wireless device during the sounding phase, each response signal received in the response window according to the timing offset of each initiating wireless device.

A non-transitory computer-readable medium storing code for wireless communications is described. The code may include instructions executable by one or more processors to transmit a sounding signal during a sounding phase of a sounding procedure, the sounding signal indicating multiple user fields, each user field identifying a timing offset for each initiating wireless device of multiple initiating wireless devices, where the timing offset identifies a response window associated with each initiating wireless device within the sounding phase and receive a response signal from each initiating wireless device during the sounding phase, each response signal received in the response window according to the timing offset of each initiating wireless device.

In some examples of the method, responding wireless devices, and non-transitory computer-readable medium described herein, the response window occurs within a single null data packet transmission period scheduled in the sounding phase.

In some examples of the method, responding wireless devices, and non-transitory computer-readable medium described herein, receiving the response signal may include operations, features, means, or instructions for receiving a common portion of the response signal from each initiating wireless device during a first period of the single null data packet transmission period and receiving a device-specific portion of the response signal from each initiating wireless devices during a second period of the single null data packet transmission period, where the single null data packet transmission period includes multiple second periods and each second period may be associated with a corresponding initiating wireless device in the multiple initiating wireless devices.

In some examples of the method, responding wireless devices, and non-transitory computer-readable medium described herein, the device-specific portion includes a high efficiency short training field (HE STF) and at least one encrypted high efficiency long training field (HE-LTF) associated with the corresponding initiating wireless device.

In some examples of the method, responding wireless devices, and non-transitory computer-readable medium described herein, the device-specific portion includes a HE STF and at least one unencrypted HE-LTF associated with the corresponding initiating wireless device.

In some examples of the method, responding wireless devices, and non-transitory computer-readable medium described herein, the timing offset includes a long training field (LTF) offset indicator.

In some examples of the method, responding wireless devices, and non-transitory computer-readable medium described herein, the response window occurs within a device-specific null data packet transmission period of multiple null data packet transmission periods scheduled during the sounding phase, each device-specific null data packet transmission period may be associated with a corresponding initiating wireless device in the multiple initiating wireless devices.

In some examples of the method, responding wireless devices, and non-transitory computer-readable medium described herein, receiving the response signal may include operations, features, means, or instructions for receiving the response signal during the device-specific null data packet transmission period of the corresponding initiating wireless device.

In some examples of the method, responding wireless devices, and non-transitory computer-readable medium described herein, the timing offset identifies a starting time for the device-specific null data packet transmission period associated with the corresponding initiating wireless device.

In some examples of the method, responding wireless devices, and non-transitory computer-readable medium described herein, the sounding signal includes a length parameter associated with the device-specific null data packet transmission period.

In some examples of the method, responding wireless devices, and non-transitory computer-readable medium described herein, the sounding procedure may be performed in an extremely high throughput (EHT) 320-megahertz channel.

Some examples of the method, responding wireless devices, and non-transitory computer-readable medium described herein may further include operations, features, means, or instructions for transmitting a polling signal during a polling phase of the sounding procedure and receiving a polling response from each initiating wireless device, where the multiple initiating wireless devices may be identified based on the polling response.

A method for wireless communications by an initiating wireless device is described. The method may include receiving a sounding signal during a sounding phase of a sounding procedure, the sounding signal indicating multiple user fields, each user field identifying a timing offset for each initiating wireless device of multiple initiating wireless devices, where the timing offset identifies a response window associated with the initiating wireless device within the sounding phase and transmitting a response signal during the response window according to the timing offset of the initiating wireless device.

An initiating wireless device for wireless communications is described. The initiating wireless device may include a processing system that includes processor circuitry and memory circuitry that stores code. The processing system may be configured to cause the initiating wireless device to receive a sounding signal during a sounding phase of a sounding procedure, the sounding signal indicating multiple user fields, each user field identifying a timing offset for each initiating wireless device of multiple initiating wireless devices, where the timing offset identifies a response window associated with the initiating wireless device within the sounding phase and transmit a response signal during the response window according to the timing offset of the initiating wireless device.

Another initiating wireless device for wireless communications is described. The initiating wireless device may include means for receiving a sounding signal during a sounding phase of a sounding procedure, the sounding signal indicating multiple user fields, each user field identifying a timing offset for each initiating wireless device of multiple initiating wireless devices, where the timing offset identifies a response window associated with the initiating wireless device within the sounding phase and means for transmitting a response signal during the response window according to the timing offset of the initiating wireless device.

A non-transitory computer-readable medium storing code for wireless communications is described. The code may include instructions executable by one or more processors to receive a sounding signal during a sounding phase of a sounding procedure, the sounding signal indicating multiple user fields, each user field identifying a timing offset for each initiating wireless device of multiple initiating wireless devices, where the timing offset identifies a response window associated with the initiating wireless device within the sounding phase and transmit a response signal during the response window according to the timing offset of the initiating wireless device.

In some examples of the method, initiating wireless devices, and non-transitory computer-readable medium described herein, the response window occurs within a single null data packet transmission period scheduled in the sounding phase.

In some examples of the method, initiating wireless devices, and non-transitory computer-readable medium described herein, transmitting the response signal may include operations, features, means, or instructions for transmitting a common portion of the response signal during a first period of the single null data packet transmission period and transmitting a device-specific portion of the response signal during a second period of the single null data packet transmission period, where the single null data packet transmission period includes multiple second periods and each second period may be associated with a corresponding initiating wireless device in the multiple initiating wireless devices.

In some examples of the method, initiating wireless devices, and non-transitory computer-readable medium described herein, the device-specific portion includes a HE STF and at least one encrypted HE-LTF associated with the initiating wireless device.

In some examples of the method, initiating wireless devices, and non-transitory computer-readable medium described herein, the device-specific portion includes a HE STF and at least one unencrypted HE-LTF associated with the initiating wireless device.

In some examples of the method, initiating wireless devices, and non-transitory computer-readable medium described herein, the timing offset includes a LTF offset indicator.

In some examples of the method, initiating wireless devices, and non-transitory computer-readable medium described herein, the response window occurs within a device-specific null data packet transmission period of multiple null data packet transmission periods scheduled during the sounding phase, each device-specific null data packet transmission period may be associated with a corresponding initiating wireless device in the multiple initiating wireless devices.

In some examples of the method, initiating wireless devices, and non-transitory computer-readable medium described herein, transmitting the response signal may include operations, features, means, or instructions for transmitting the response signal during the device-specific null data packet transmission period of the initiating wireless device.

In some examples of the method, initiating wireless devices, and non-transitory computer-readable medium described herein, the timing offset identifies a starting time for the device-specific null data packet transmission period associated with the initiating wireless device.

In some examples of the method, initiating wireless devices, and non-transitory computer-readable medium described herein, the sounding signal includes a length parameter associated with the device-specific null data packet transmission period.

In some examples of the method, initiating wireless devices, and non-transitory computer-readable medium described herein, the sounding procedure may be performed in an EHT 320-megahertz channel.

Some examples of the method, initiating wireless devices, and non-transitory computer-readable medium described herein may further include operations, features, means, or instructions for receiving a polling signal during a polling phase of the sounding procedure and transmitting a polling response from each initiating wireless device, where the initiating wireless device may be included in the multiple initiating wireless devices based on the polling response.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a sounding model that supports single trigger frame use for trigger-based ranging (TBR) sounding modes.

FIG. 6 shows an example of a sounding model that supports single trigger frame use for TBR sounding modes.

FIG. 7 shows an example of a sounding model that supports single trigger frame use for TBR sounding modes.

FIG. 8 shows a block diagram of an example wireless communication device that supports single trigger frame use for TBR sounding modes.

FIG. 9 shows a flowchart illustrating an example process performable by or at a responding wireless device that supports single trigger frame use for TBR sounding modes.

FIG. 10 shows a flowchart illustrating an example process performable by or at an initiating wireless device that supports single trigger frame use for TBR sounding modes.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to trigger based ranging (TBR) techniques. Some aspects more specifically relate to TBR techniques using a single trigger frame (TF) during the sounding procedure (such as rather than per-device TF transmissions). The sounding procedure may begin with a TF ranging poll transmission (such as a polling signal) from a responding wireless station (RSTA) during a polling phase of the sounding procedure. Initiating wireless station(s) (ISTA) (s) may respond to the TF ranging poll by transmitting a clear-to-send (CTS)-to-self, with each ISTA transmitting the CTS-to-self forming a set or group of multiple ISTAs from the perspective of the RSTA. The sounding procedure may proceed to the sounding phase where the RSTA transmits a single TF ranging sounding (such as a sounding signal). Each ISTA in the group of ISTAs may respond to the single TF ranging sounding by transmitting a response signal (such as a null data packet (NDP)) during a unique response window that corresponds to that ISTA (such as using a time division multiplexing scheme).

The TF ranging sounding may carry or otherwise convey an indication of multiple user fields. The number of user fields indicated in the TF ranging sounding may be based on the number of ISTAs transmitting the CTS-to-self. That is, the RSTA may include or otherwise indicate a user field in the TF ranging sounding transmission that corresponds to each ISTA that transmitted the CTS-to-self during the polling phase. Each user field may carry or otherwise convey an indication of a timing offset for each ISTA. Each user field may be set to a value that identifies, for the corresponding ISTA, the response window during which the ISTA is to transmit the NDP to the RSTA. For example, each user field may be set to a value or otherwise indicate a timing offset during which, for the ISTA corresponding to that user field, that ISTA is to transmit the NDP during the sounding phase of the sounding procedure.

In some aspects, a single response window (such as a single NDP transmission period) or device-specific response windows (such as device-specific NDP transmission periods) may be used during which an ISTA will provide its response signal based on the single TF. For example, a single NDP transmission period may be used by each ISTA responding to the TF ranging sounding. The response window may include a common portion where each ISTA transmits its response signal (such as a first portion of the response signal) and also include device-specific portions during which individual ISTA transmits its response signal (such as a second portion of the response signal) according to its timing offset. For example, the device-specific portions of the response signal may correspond to a high efficiency short training field (HE STF) and a high efficiency long training field (HE LTF) (or multiple HE LTF) for the corresponding ISTA. The HE LTF may be encrypted for TBR MU secure sounding or may be unencrypted for TBR non-secure sounding.

The device-specific response windows may include individual device-specific NDP transmission periods corresponding to each ISTA. For example, the timing offset indicated in the TF ranging sounding for each ISTA may identify the device-specific NDP transmission period for that ISTA. Each ISTA providing a response signal may use its timing offset indicated in its corresponding user field of the TF ranging sounding transmission to identify or otherwise determine its device-specific NDP transmission period. The ISTA may transmit its response signal during its corresponding device-specific NDP transmission period.

Particular aspects of the subject matter described in this disclosure can realize one or more of the following potential advantages. In some examples, by using a single TF ranging sounding transmission, the described techniques can improve channel efficiency. TF ranging sounding transmission and NDP response signal designs on a per-ISTA basis may be avoided using the single TF ranging sounding transmission from the RSTA. The TF ranging sounding transmission identifying per-device user fields may facilitate time multiplexing response signal transmissions in response to the single TF ranging sounding transmission. The latency associated with the measurement and reporting phase of the sounding procedure may be reduced by avoiding the one-to-one TF ranging sounding/I2R NDP cycle. Over-the-air resources may be conserved and interference may be reduced by reducing the number of TF ranging sounding transmissions over the wireless channel during the sounding procedure.

Single TF ranging sounding transmissions to solicit ISTA-to-RSTA (I2R) NDP from each ISTA may optimize the TBR secure mode and non-secure mode sounding. The time multiplexing aspects for the response signal transmissions from each ISTA according to the timing offset may eliminate or otherwise overcome the spatial feature limitations of the RSTA applicable during conventional non-secure TBR sounding.

Grouping of ISTAs in a ranging sequence may be limited by the number of HE LTF repetitions supported by the ISTA. Users with mixed HE LTF repetition support may be grouped in the same ranging sequence. For example, more relevant factors may be considered for ISTA grouping, such as priority. This approach may provide improved (e.g., more relaxed) scheduling algorithms for ISTA grouping.

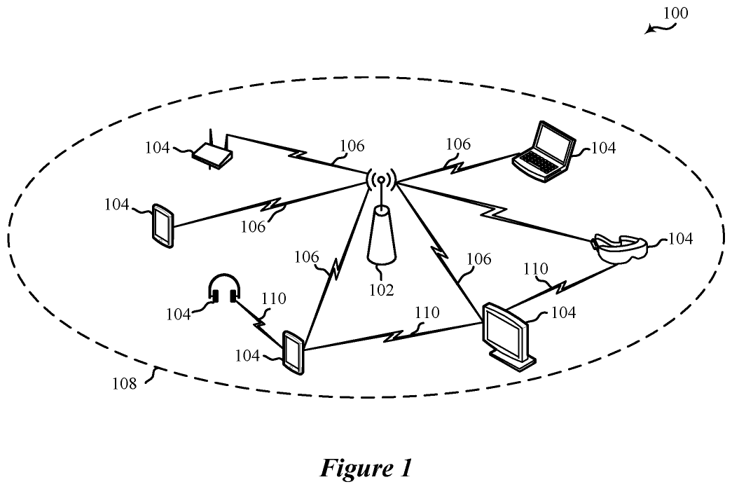

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHZ-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

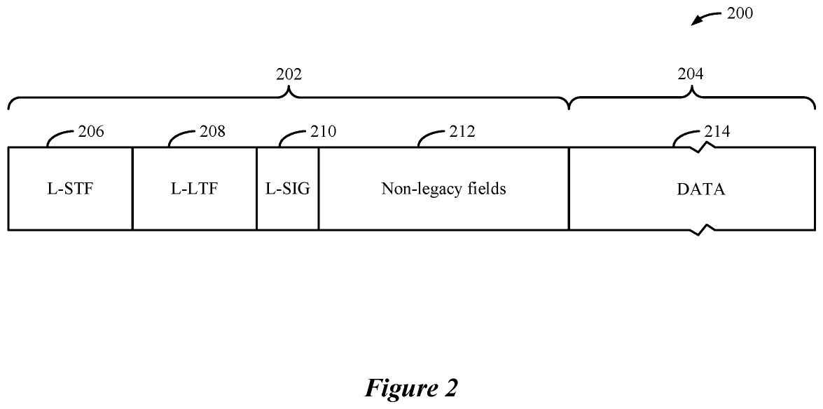

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

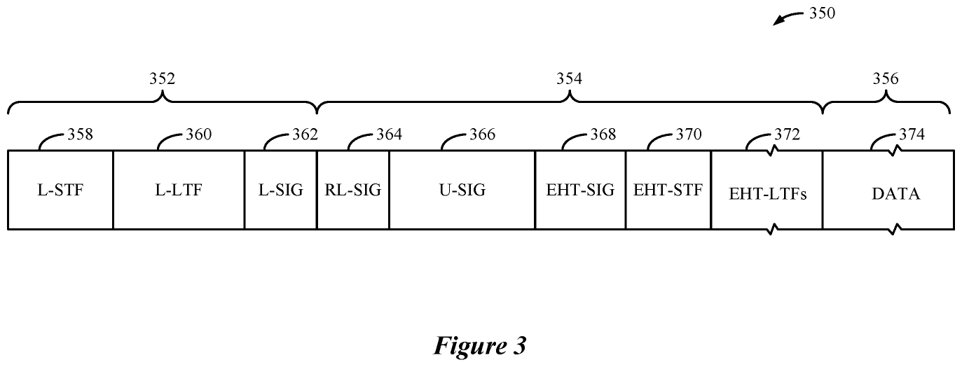

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

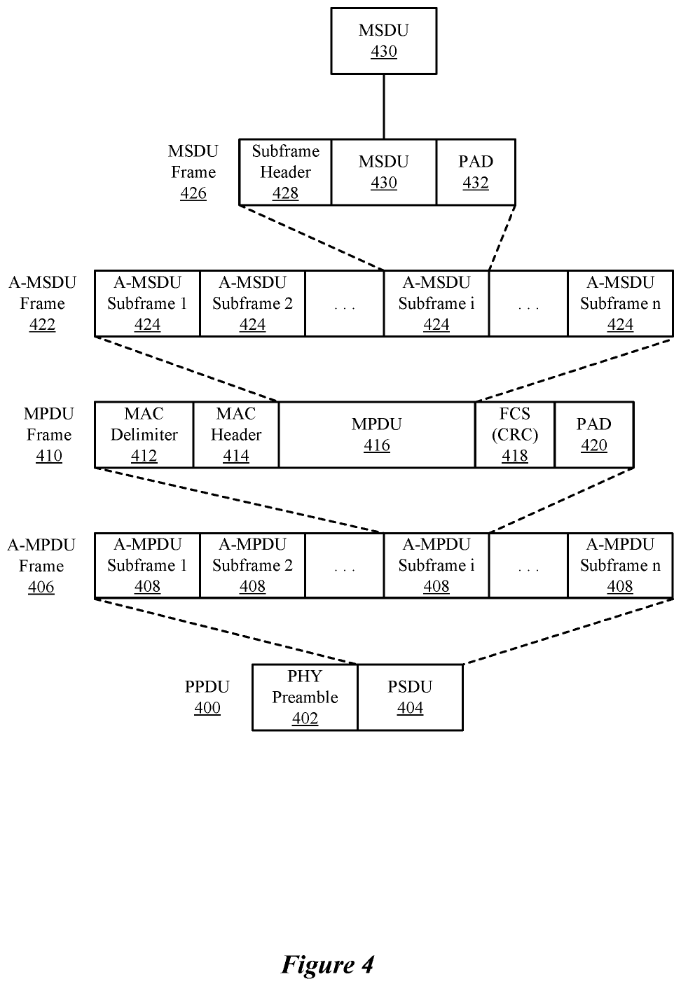

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

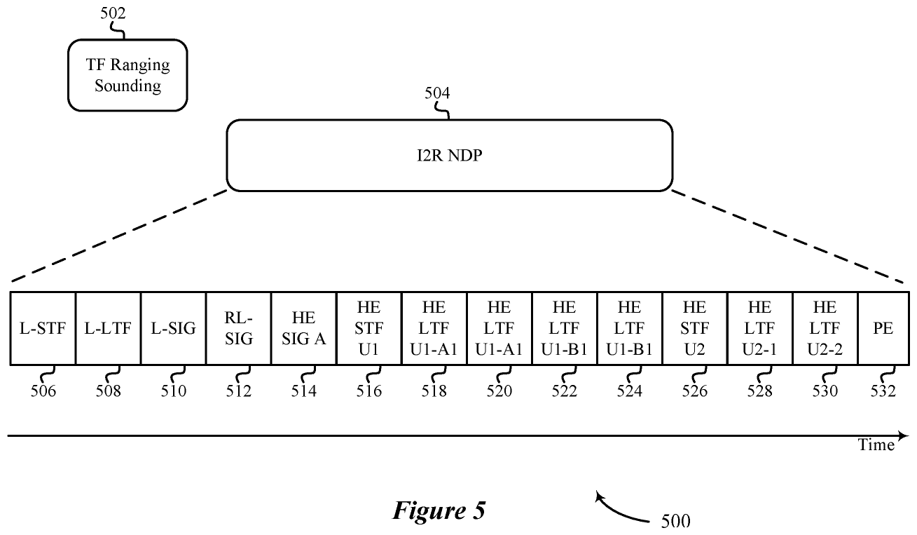

FIG. 5 shows an example of a sounding model 500 that supports single trigger frame use for TBR sounding modes. Aspects of sounding model 500 may be implemented at or implemented by a RSTA or an ISTA, which may be examples of the corresponding devices described herein. For example, the RSTA and the ISTA may be an example of a STA 104 as shown and described with reference to FIG. 1. Sounding model 500 may be a non-limiting example of a single TF being used for TBR MU secure mode sounding or for TBR MU non-secure mode sounding.

Sounding procedures are generally used to measure and report various channel performance metrics of the wireless medium (such as the channel) over which signal transmissions are propagated. The sounding procedures may include a transmitting device transmitting a signal over the medium and a receiving device measuring various metrics of the signal. Comparing the measured metrics with known metrics of the signal enables the wireless devices to identify or otherwise determine how the channel is performing. The wireless devices may use the measured channel performance metrics to make various scheduling, allocation, and other parameter selections that improve ongoing wireless communications between the wireless devices.

One example of such sounding procedures includes TBR MU sounding between RSTA(s) and ISTA(s). TBR sounding may be divided into a polling phase, a measurement sounding phase, and a measurement reporting phase. The polling phase begins with a RSTA transmitting a TF ranging poll signal over the wireless medium. ISTAs that receive the TF ranging poll may respond by transmitting a CTS-to-self signal over the wireless medium. The CTS-to-self transmissions may indicate that the ISTA are participating in the sounding procedure, which may form the group of ISTAs.

In some wireless networks, the sounding phase generally includes a one-to-one sounding process where the RSTA transmits a TF ranging sounding (such as a sounding signal) and one ISTA responds by transmitting an I2R NDP. This means that for every ISTA who responded to the TF ranging poll with a CTS-to-self in the polling phase, the RSTA needs to send the TF ranging sounding and receive the I2R NDP for every ISTA. Moreover, each transmission is separated by a SIFS, which increases the latency associated with such sounding. The sounding procedure may proceed to the measurement and reporting phase where the results of the sounding are identified and provided.

For N ISTAs in the group, this results in the one-to-one sounding process being repeated N times during the sounding phase. This approach is inefficient in terms of channel use and latency, with the inefficiency and latency increasing further as the number of ISTAs in the group increases. Moreover, the number of ISTAs that can be sounded (such as in the group) may be limited based on the duration of the TxOP during which the sounding procedure is performed. As one non-limiting example where the maximum number of ISTAs in the group is eight (such as N=8), the TF sounding time to complete the sounding phased may be reduced compared to one-to-one RSTA/ISTA ranging sequences.

Accordingly, aspects of the techniques described herein include using a single TF transmission by the RSTA during the sounding phase to solicit I2R NDP transmissions from each ISTA in an optimal manner. The sounding procedure described herein may be performed over a channel having various bandwidths, such as a 40 MHz channel, an 80 MHz channel, a 160 MHz channel, a 240 MHz channel, a 320 MHz channel, or over a channel having a wider bandwidth. In some examples, the sounding procedure may be performed in an EHT 320 MHz channel. Aspects of the described techniques may multiplex in the time domain the I2R NDP response signal transmissions from ISTAs in the group of multiple ISTAs.

The RSTA may transmit a sounding signal 502 during the sounding phase of the sounding procedure. For example, the RSTA may have transmitted the polling signal (such as the TF ranging poll) during the polling phase of the sounding procedure. The RSTA may have received a polling response (such as the CTS-to-self) from each ISTA based on the polling signal. The RSTA may have identified or otherwise formed the group of ISTAs according to the polling responses.

The sounding signal 502 may include multiple user fields, with each user field corresponding to or otherwise associated with an individual ISTA in the group of multiple ISTAs. For example, the sounding signal 502 may include multiple user fields and each user field may carry or otherwise convey user-specific information for the corresponding ISTA in the group of multiple ISTAs. Each user field in the sounding signal 502 may include a security authentication code (SAC) field that provides the sounding security during the sounding instance for the corresponding ISTA. In some examples, the SAC field may use 16 bits within the sounding signal 502.

Each user field in the sounding signal 502 also may include a timing offset for the corresponding ISTA. The timing offset may generally identify a period within the response window for the ISTA. In the non-limiting example shown in FIG. 5, the response window may be or otherwise occur within a single NDP transmission period scheduled in the sounding phase. That is, the single TF sounding may be followed by a single I2R NDP that include HE STFs and HE LTFs from all ISTAs in the group of multiple ISTAs.

The response window may generally define the time period that the corresponding ISTA will transmit its I2R NDP. The timing offset indicated in the user field of the sounding signal 502 may identify, within the single response window of the single NDP transmission period, when the corresponding ISTA will transmit or otherwise provide its I2R NDP response signal to the RSTA. The single NDP transmission period may correspond (such as in the time domain) to the I2R NDP 504. That is, the response window for the RSTA to receive a response signal from the ISTAs within the group of multiple ISTAs may be a single response window that is divided in the time domain such that each ISTA may transmit some or all of its I2R NDP response signal.

For example, the timing offset in the sounding signal 502 may include an LTF offset field that represents the LTF offset after which each ISTA is to transmit its HE STF and HE LTF during the response window of the I2R NDP 504. In some aspects, the bit field indicating the LTF offset may support a maximum (such as satisfying a LTF timing threshold) LTF offset for the N ISTAs in the group based on a maximum number of ISTAs supported by the RSTA and the maximum LTF per-ISTA.

Accordingly, the RSTA may receive or otherwise obtain a common portion of the response signal from each ISTA during a first period of the single NDP transmission period. The response window for the single NDP transmission period in this example may be divided into a first period for the ISTAs to transmit or output a common portion of the response signal and multiple second periods (such as one second period for each ISTA in the group of multiple ISTAs) that may be used for corresponding ISTA to transmit or output a device-specific portion of the response signal (such as its HE LTF and HE STF). The RSTA may receive up to HE SIG A 514 (e.g., including receiving preamble portions L-STF 506, L-LTF 508, L-SIG 510, and RL-SIG 512) that is transmitted from each ISTA in the group of multiple ISTAs during the first period of the response window. The timing offset indicated in the sounding signal 502 may identify, for each ISTA, when its corresponding second period occurs within the response window. Each ISTA participating in the sounding procedure may transmit or otherwise output up to HE SIG A 514 during the first period. Up to HE SIG A 514, in this example, may correspond to the common portion of the response window.

In the non-limiting example shown in FIG. 5, the single NDP transmission period within the response window may be used for two ISTAs (identified as U1 and U2) to provide I2R NDP response signal transmissions. The first user (such as a first ISTA identified as U1) may be allocated or otherwise configured to transmit two repetitions with two HE LTF per repetition and the second user (such as a second ISTA identified as U2) may be allocated or otherwise configured with two repetitions with one HE LTF per repetition.

Accordingly, the RSTA may receive or otherwise obtain a device-specific portion of the response signal from each ISTA during a second period of the single NDP transmission period. For example, the RSTA may receive a HE STF 516, a HE LTF 518, a HE LTF 520, a HE LTF 522, and a HE LTF 524 from the first ISTA (U1) in the group of multiple ISTAs. The HE STF 516, the HE LTF 518, the HE LTF 520, the HE LTF 522, and the HE LTF 524 may form a device-specific portion of the response signal for the first ISTA. In this example, the HE LTF 518 and the HE LTF 520 may form the first repetition (such as U1-A1) of the I2R NDP that includes two HE LTFs while the HE LTF 522 and the HE LTF 524 may form the second repetition (such as U1-B1) of the I2R NDP that also includes two HE LTF. The first ISTA may identify or otherwise determine its second period for transmitting its device-specific portion of the response signal based on the timing offset indicated in its corresponding user field in the sounding signal 502.

The RSTA may receive a HE STF 526, a HE LTF 528, and a HE LTF 530 from the second ISTA (U2) in the group of multiple ISTAs. The HE STF 526, the HE LTF 528, and the HE LTF 530 may for the device-specific portion of the response signal for the second ISTA. In this example, the HE LTF 528 may form the first reception (such as U2-1) of the I2R NDP that includes one HE LTF while the HE LTF 530 may form the second repletion (such as U2-2) of the I2R NDP that also includes one HE LTF repetition. The second ISTA may identify or otherwise determine its second period for transmitting its device-specific portion of the response signal based on the timing offset indicated in its corresponding user field in the sounding signal 502. The RSTA may receive or otherwise obtain a packet extension (PE) 532 transmitted from a last ISTA in the group of multiple ISTAs. For example, the sounding signal 502 may include one or more bits indicating that the last ISTA in the group of multiple ISTAs is to transmit the PE 532. Having a dedicated bit in the TF ranging sounding for the PE 532 indication for the last user (e.g., the last ISTA) may be set to a value for or otherwise associated with the last ISTA that is to send the PE 532. The total I2R NDP length may be fixed and present in the uplink length field of the common information field format of the TF ranging sounding signal. All of the ISTAs in the group may have the knowledge or otherwise be aware of the total I2R NDP length. The L-SIG 510 length may also capture the duration of the I2R NDP remaining after the L-SIG 510. Using the LTF offset indication, the I2R NDP duration and knowledge of the total HE LTFs an ISTA is to transmit, the last user (e.g., the last ISTA) indication may be self-obtained by an ISTA.

During the period when one ISTA is transmitting its device-specific portion of the response signal, the other ISTAs within the group may transmit zero samples (e.g., may not transmit during this period).

The HE STF transmissions may be used per-user (such as U1 and U2) during the single NDP transmission period of the response window to enable the RSTA to receive the HE LTF transmissions. For example, the RSTA may use the HE STF 516 to perform automatic gain control (AGC) or other synchronization functions for the first ISTA to improve reception of the HE LTF 518, the HE LTF 520, the HE LTF 522, and the HE LTF 524. Similarly, the RSTA may use the HE STF 526 to improve reception of the HE LTF 528 and the HE LTF 530 from the second ISTA. Although the described techniques generally include HE LTF transmissions from the ISTAs, it is to be understood that the device-specific portions of the response signals may be enhanced HE LTFs (such as EHT LTFs), such as in other examples.

Accordingly, each device-specific portion of the response signal may include a HE STF and at least one, or more than one, HE LTF associated with (such as transmitted from) the corresponding ISTA. In some examples, the HE LTF(s) may be encrypted HE LTF(s). That is, aspects of the sounding techniques described herein may be used during TBR MU secure sounding between the RSTA and the ISTAs in the group of multiple ISTAs. Accordingly, in this example each ISTA transmitting its I2R NDP response signal may encrypt or otherwise secure the HE LTF(s) before transmission during the single NDP transmission period of the response window.

However, in some other examples the techniques described herein may be used during TBR MU non-secure sounding between the RSTA and the ISTAs. For TBR MU non-secure sounding, the HE LTF(s) transmitted by each ISTA in the group of multiple ISTAs may be unencrypted or otherwise non-secure. The time multiplexing aspects of the described techniques may be further advantageous during non-secure TBR MU sounding. For example, in some wireless networks the number of ISTAs that can be accommodated in a single TBR MU non-secure sounding may be limited by the number of spatial streams supported by the RSTA. Multiple ranging sequences may be required in such instances, such as when N ISTAs are included in the group of multiple ISTAs and the RSTA does not support N spatial streams. The described techniques where the I2R NDP transmissions are multiplexed in the time domain according to the timing offset indicated in the sounding signal 502 may avoid additional ranging instances during the sounding procedure as the number of ISTAs is not limited by the spatial stream capabilities of the RSTA.

Moreover, in TBR MU non-secure sounding the grouping of ISTAs in a ranging sequence may be limited by the ISTAs having the same number of HE LTF repetitions that are supported by the ISTA. However, users with mixed HE LTF repetition support can be grouped in the same ranging sequence (such as based on priority or other factors) using the techniques described herein. The described techniques may provide additional savings in the time domain in the situation where the users are scheduled in different TxOPs according to other techniques. For TBR MU non-secure sounding, the sounding signal 502 may omit the SAC field, but may use the user fields to indicate the timing offset (such as the LTF offset) for each ISTA in the group of multiple ISTAs.

In some aspects, the length of the single NDP transmission period (such as shown as the I2R NDP 504) may be based on the maximum number of HE LTF transmissions and users supported per-packet. For example, a maximum of 64 HE LTFs may be supported in an NDP. In the example where N=8 users being scheduled during the sounding procedure, eight HE STFs may be used for the I2R NDP transmission period. Accordingly, one HE STF may be included in the I2R NDP transmission period, with one HE STF per user being included.

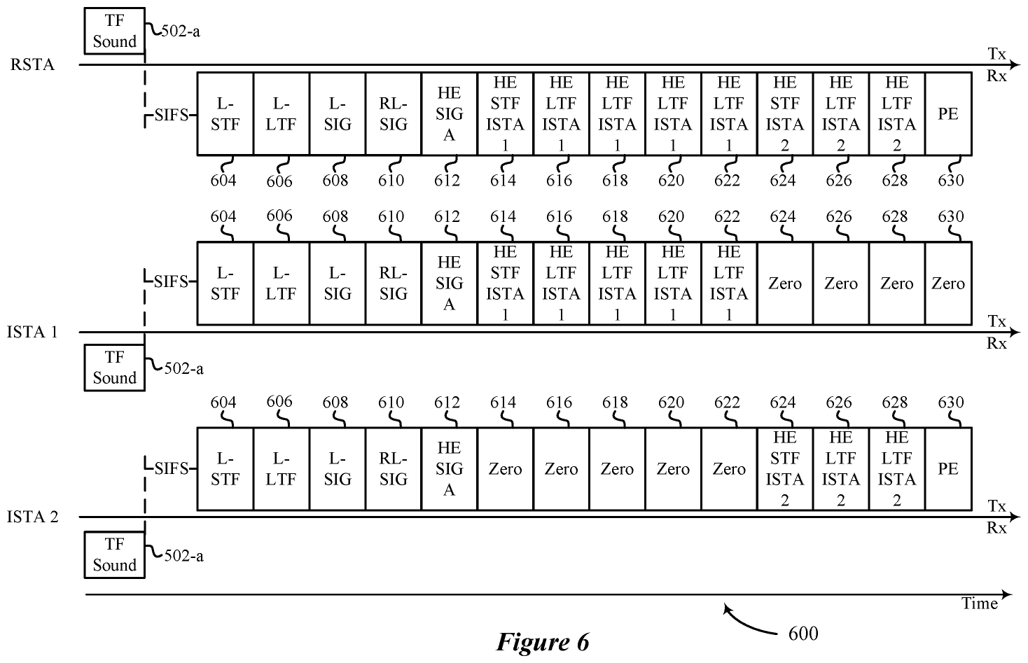

FIG. 6 shows an example of a sounding model 600 that supports single trigger frame use for TBR sounding modes. Aspects of sounding model 600 may be implemented at or implemented by a RSTA or an ISTA, which may be examples of the corresponding devices described herein. For example, the RSTA and the ISTA may be an example of a STA 104 as shown and described with reference to FIG. 1. Sounding model 600 may be a non-limiting example of a single TF being used for TBR MU secure mode sounding or for TBR MU non-secure mode sounding.

As discussed above, aspects of the techniques described herein include using a single TF transmission by the RSTA during the sounding phase to solicit I2R NDP transmissions from each ISTA in an optimal manner. Aspects of the described techniques may multiplex in the time domain the I2R NDP response signal transmissions from ISTAs in the group of multiple ISTAs. Sounding model 600 shows a non-limiting example of the techniques described herein from the perspective of the RSTA, a first ISTA (ISTA 1) and a second ISTA (ISTA 2) in the group of multiple ISTAs.

For example, the RSTA may transmit (Tx) or otherwise output a sounding signal 502-a to the ISTAs in the group of multiple ISTAs. The first ISTA and the second ISTA may each receive (Rx) or otherwise obtain the sounding signal 502-a from the RSTA. The sounding signal 502-a may carry or otherwise convey an indication of multiple user fields where each user field corresponds to an ISTA in the group of multiple ISTAs. For example, the sounding signal 502-a may include or otherwise indicate a first user field for the first ISTA and a second user field for the second ISTA. It is to be understood that the number of user fields may be based on the number of ISTAs in the group of multiple ISTAs (such as one user field per ISTA), which may include more than two user fields.

Each user field may indicate or otherwise identify a timing offset for the corresponding ISTA. For example, the first user field may indicate a first timing offset for the first ISTA and the second user field may indicate a second timing offset for the second ISTA. The timing offset generally identifies a response window for the corresponding ISTA. The timing offset may be indicated in an LTF offset indicator for the corresponding ISTA. In the non-limiting example shown in FIG. 6, the response window may occur within a single NDP transmission period (such as such as the I2R NDP 504, described with reference to FIG. 5).

The RSTA may receive or otherwise obtain a response signal from each ISTA during the sounding phase of the sounding procedure. However, each response signal may be received in the response window according to the timing offset of each ISTA. That is, the single NDP transmission period may be divided or otherwise multiplexed in the time domain such that different periods in the time domain are allocated to individual ISTAs responding to the sounding signal 502-a transmission. The single NDP transmission period may include a common portion of the response signal received from each ISTA during a first period and device-specific portions of the response signal received from each ISTA during a second period. Multiple second periods may be included in the single NDP transmissions period, with each second period corresponding to a specific ISTA.

For example, both of the first ISTA and the second ISTA may transmit or otherwise output a common portion of the response signal during the first period of the single NDP transmission period. The common portion of the response signal in this example may correspond to the first ISTA and the second ISTA transmitting up to HE SIG A 612, which may include preamble portions L-STF 604, L-LTF 606, L-SIG 608, and RL-SIG 610. The RSTA may receive up to HE SIG A 612 transmissions (e.g., including receiving preamble portions L-STF 604, L-LTF 606, L-SIG 608, and RL-SIG 610) from the first ISTA and from the second ISTA.

The RSTA may receive a device-specific portion of the response signal from each ISTA during a second period of the single NDP transmission period. The second period, in this example, may correspond to or otherwise be associated with a corresponding ISTA in the group of multiple ISTAs. For example, during a first of the second periods the first ISTA may transmit or otherwise output a HE STF 614, a HE LTF 616, a HE LTF 618, a HE LTF 620, and a HE LTF 622 to the RSTA. The HE STF and the HE LTFs transmitted during this second period may be transmitted according to the timing offset indicated in the corresponding user field of the sounding signal 502-a. That is, the timing offset indicated in the user field for the first ISTA may identify when, during the single NDP transmission period, that the first ISTA is to transmit its device-specific portion of the response signal. The second ISTA may transmit zero samples during this first of the second periods. For example, the second ISTA may refrain from transmitting any signal during the second period of the first ISTA.

However, the second ISTA may transmit its device-specific portion of the response signal during a second of the second periods to the RSTA. For example, the RSTA may transmit a HE STF 624, a HE LTF 626, and a HE LTF 628, during its second period according to the timing offset indicated in the second user field. The HE STF and the HE LTFs transmitting during this second period may be transmitted according to the timing offset indicated in the user field for the second ISTA of the sounding signal 502-a. That is, timing offset indicated in the user field for the second ISTA may identify when, during the single NDP transmission period, that the second ISTA is to transmit its device-specific portion of the response signal. During this second period, the first ISTA may again transmit zero samples. For example, the first ISTA may refrain from transmitting any signal during the second period of the second ISTA.

Accordingly, the RSTA may receive or otherwise obtain the HE STF 614, the HE LTF 616, the HE LTF 618, the HE LTF 620, and the HE LTF 622 from the first ISTA during a first of the second periods (such as the response window of the first ISTA) of the single NDP transmission period and receive the HE STF 624, the HE LTF 626, and the HE LTF 628 from the second ISTA during a second of the second periods (such as the response window of the second ISTA) of the single NDP transmission period. The RSTA may receive or otherwise obtain a PE 630 transmitted from the second ISTA (e.g., from the last ISTA in the group of multiple ISTAs) during the single NDP transmission period. For example, the sounding signal 502-a may include or otherwise carry one or more bits indicating that the last ISTA within the group is to transmit the PE 630 to the RSTA. The HE LTFs transmitted by each ISTA may be provided with or without repetitions, with each repetition having one or more HE LTFs.

As discussed above, the HE LTFs transmitted by each ISTA may be encrypted for TBR MU secure sounding or may be unencrypted for TBR MU non-secure sounding. Moreover, the HE LTFs may include EHT LTFs in some examples.

Accordingly, sounding model 600 illustrates a non-limiting example of a single TF ranging sounding (such as the sounding signal 502-a) being used during the sounding phase of a sounding procedure. The TF ranging sounding may include multiple user fields that identify a timing offset for each ISTA participating in the sounding procedure. Each ISTA may transmit its response signal during its response window, with the timing of individual ISTA I2R NDP transmissions being identified by the timing offset indicated in the sounding signal 502-a.

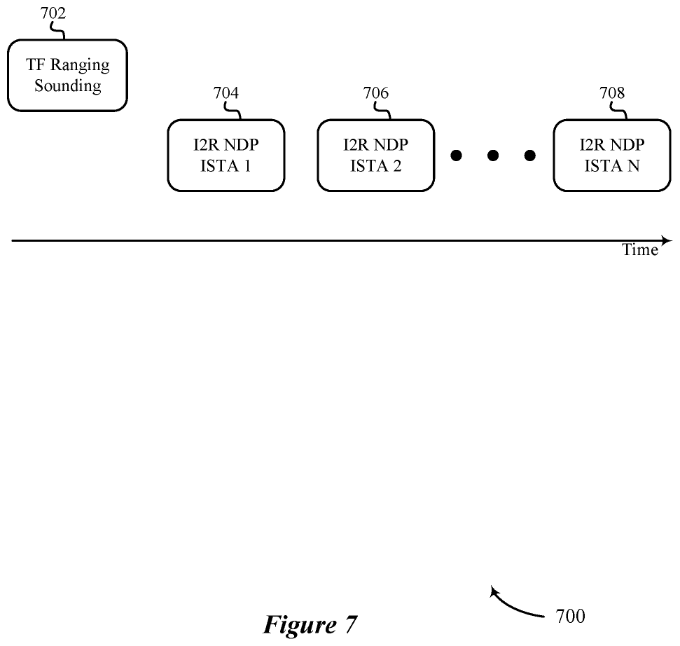

FIG. 7 shows an example of a sounding model 700 that supports single trigger frame use for TBR sounding modes. Aspects of sounding model 700 may be implemented at or implemented by a RSTA or an ISTA, which may be examples of the corresponding devices described herein. For example, the RSTA and the ISTA may be an example of a STA 104 as shown and described with reference to FIG. 1. Sounding model 700 may be a non-limiting example of a single TF being used for TBR MU secure mode sounding or for TBR MU non-secure mode sounding.

As discussed above, aspects of the techniques described herein include using a single TF transmission by the RSTA during the sounding phase to solicit I2R NDP transmissions from each ISTA in an optimal manner. Aspects of the described techniques may multiplex in the time domain the I2R NDP response signal transmissions from ISTAs in the group of multiple ISTAs. Sounding model 700 shows a non-limiting example of the techniques described herein wherein device-specific NDP transmission periods are scheduled during the sounding phase. Broadly, each device-specific NDP transmission period may be associated with or otherwise correspond to an ISTA in the group of multiple ISTAs.

For example, the RSTA may transmit or otherwise output a sounding signal 702 during the sounding phase of the sounding procedure. The sounding signal 702 may be transmitted to the ISTAs in the group of multiple ISTAs. The number of ISTAs in the group of multiple ISTAs may be represented by N, with N being a positive integer. The sounding signal 702 may include multiple user fields with each user field corresponding to an individual ISTA in the group of multiple ISTAs. For example, the sounding signal 702 may carry or otherwise convey an indication of a first user field for a first ISTA, a second user field for a second ISTA, and so on for the N ISTAs in the group of multiple ISTAs.

Each user field may carry or otherwise convey an indication of a timing offset for the corresponding ISTA. The timing offset may identify the beginning of the response window during which the corresponding ISTA is to provide its response signal (such as I2R NDP) based on the sounding signal 702. Sounding model 700 illustrates a non-limiting example where the single TF sounding (such as the sounding signal 702) is followed by multiple I2R NDPs. That is, the response window identified by the timing offset may correspond to a device-specific NDP transmission period during the sounding phase. For example, the first timing offset indicated in the first user field may identify a first I2R NDP transmission period for the first ISTA, the second timing offset indicated in the sounding signal 702 may identify a second I2R NDP transmission period for the second ISTA, and so on for each ISTA in the group of multiple ISTAs. The RSTA may receive a response signal (such as an I2R NDP) from each ISTA according to the timing offset of that ISTA.

For example, the RSTA may receive an I2R NDP 704 from a first ISTA (ISTA 1) during the first response window, with the first response window forming a first device-specific NDP transmission period. The RSTA may receive an I2R NDP 706 from a second ISTA (ISTA 2) during the second response window, with the second response window forming a second device-specific NDP transmission period. This may continue until the RSTA receives an I2R NDP 708 from the N'th ISTA (ISTA N) during the Nth response window, with the Nth response window forming the Nth device-specific NDP transmission period. Accordingly, the RSTA may receive or otherwise obtain the response signal during the device-specific NDP transmission period from the corresponding ISTA. In some aspects, the timing offset indicated in the user field of the sounding signal 702 may identify, for the corresponding ISTA, the starting time of the device-specific NDP transmission period. Each of these transmissions may be separated in the time domain by a SIFS.

In some aspects, the length (such as in the time domain or in the number of bits) of the device-specific NDP transmission period may be the same for each ISTA or may be different. Accordingly, in some examples the sounding signal 702 also may carry a length parameter for the device-specific NDP transmission period. For example, each user field in the sounding signal 702 may carry or otherwise indicate, in addition to the timing offset, the length parameter for the device-specific NDP transmission period for that ISTA. The length parameter may include an uplink I2R NDP length spanning 10 bits, in some examples. The bit field may be based on the maximum ranging NDP duration being supported.

In the situation where the RSTA does not detect the I2R NDP after an SIFS, the RSTA may transmit another TF ranging sounding (followed by another CTS-to-self) to keep the channel (such as to keep the TxOP).

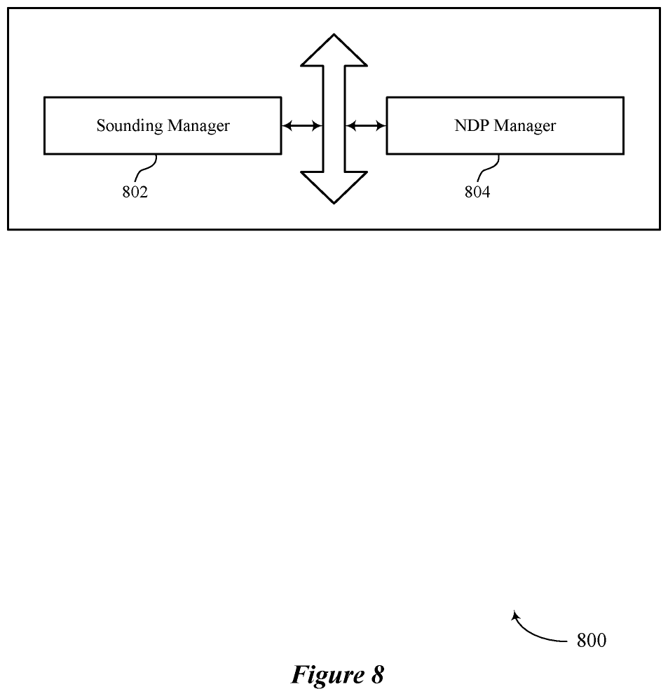

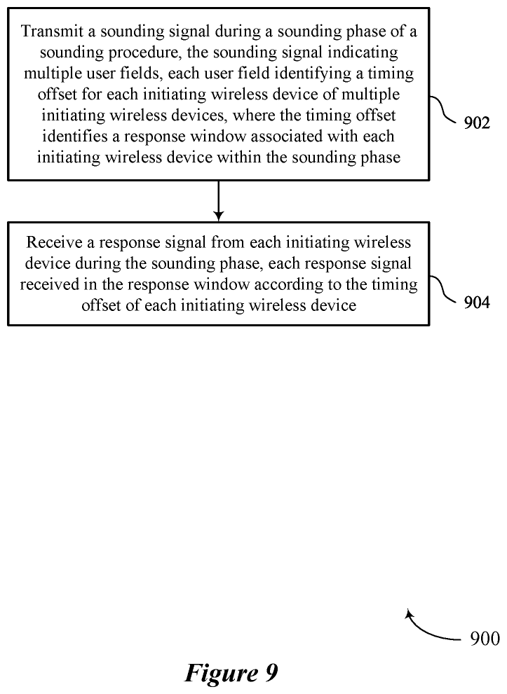

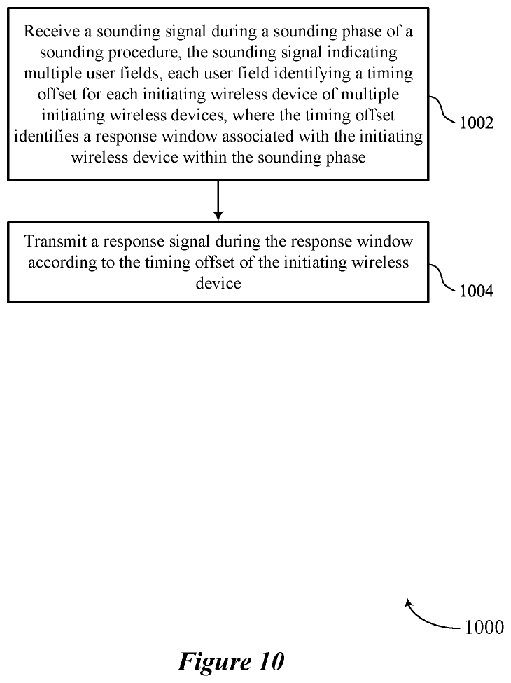

FIG. 8 shows a block diagram of an example wireless communication device 800 that supports single trigger frame use for TBR sounding modes. In some examples, the wireless communication device 800 is configured to perform the processes 900 and 1000 described with reference to FIGS. 9 and 10, respectively. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information and pass the information to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in a STA, such as the STA 104 described with reference to FIG. 1. In some other examples, the wireless communication device 800 can be a STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes a user interface (UI) (such as a touchscreen or keypad) and a display, which may be integrated with the UI to form a touchscreen display that is coupled with the processing system. In some examples, the wireless communication device 800 may further include one or more sensors such as, for example, one or more inertial sensors, accelerometers, temperature sensors, pressure sensors, or altitude sensors, that are coupled with the processing system.

The wireless communication device 800 includes a sounding manager 802 and an NDP manager 804. Portions of one or more of the sounding manager 802 and the NDP manager 804 may be implemented at least in part in hardware or firmware. For example, one or more of the sounding manager 802 and the NDP manager 804 may be implemented at least in part by at least a processor or a modem. In some examples, portions of one or more of the sounding manager 802 and the NDP manager 804 may be implemented at least in part by a processor and software in the form of processor-executable code stored in memory.

The wireless communication device 800 may support wireless communications in accordance with examples as disclosed herein. The sounding manager 802 is configurable or configured to transmit a sounding signal during a sounding phase of a sounding procedure, the sounding signal indicating multiple user fields, each user field identifying a timing offset for each initiating wireless device of multiple initiating wireless devices, where the timing offset identifies a response window associated with each initiating wireless device within the sounding phase (e.g., the SAC during secure mode sounding). The NDP manager 804 is configurable or configured to receive a response signal from each initiating wireless device during the sounding phase, each response signal received in the response window according to the timing offset of each initiating wireless device. In some examples, the response window occurs within a single NDP transmission period scheduled in the sounding phase.

In some examples, to support receiving the response signal, the NDP manager 804 is configurable or configured to receive a common portion of the response signal from each initiating wireless device during a first period of the single NDP transmission period. In some examples, to support receiving the response signal, the NDP manager 804 is configurable or configured to receive a device-specific portion of the response signal from each initiating wireless devices during a second period of the single NDP transmission period, where the single NDP transmission period includes multiple second periods and each second period is associated with a corresponding initiating wireless device in the multiple initiating wireless devices.

In some examples, the device-specific portion includes a HE STF and at least one encrypted HE-LTF associated with the corresponding initiating wireless device. In some examples, the device-specific portion includes a HE STF and at least one unencrypted HE-LTF associated with the corresponding initiating wireless device. In some examples, the timing offset includes a LTF offset indicator. In some examples, the sounding procedure may be performed in a 320 MHz channel.

In some examples, the response window occurs within a device-specific NDP transmission period of multiple NDP transmission periods scheduled during the sounding phase, each device-specific NDP transmission period is associated with a corresponding initiating wireless device in the multiple initiating wireless devices.

In some examples, to support receiving the response signal, the NDP manager 804 is configurable or configured to receive the response signal during the device-specific NDP transmission period of the corresponding initiating wireless device. In some examples, the timing offset identifies a starting time for the device-specific NDP transmission period associated with the corresponding initiating wireless device. In some examples, the sounding signal includes a length parameter associated with the device-specific NDP transmission period. In some examples, the sounding procedure is performed in an EHT 320-megahertz channel.

In some examples, the sounding manager 802 is configurable or configured to transmit a polling signal during a polling phase of the sounding procedure. In some examples, the sounding manager 802 is configurable or configured to receive a polling response from each initiating wireless device, where the multiple initiating wireless devices are identified based on the polling response.

Additionally, or alternatively, the wireless communication device 800 may support wireless communications in accordance with examples as disclosed herein. In some examples, the sounding manager 802 is configurable or configured to receive a sounding signal during a sounding phase of a sounding procedure, the sounding signal indicating multiple user fields, each user field identifying a timing offset for each initiating wireless device of multiple initiating wireless devices, where the timing offset identifies a response window associated with the initiating wireless device within the sounding phase. In some examples, the NDP manager 804 is configurable or configured to transmit a response signal during the response window according to the timing offset of the initiating wireless device. In some examples, the response window occurs within a single NDP transmission period scheduled in the sounding phase.

In some examples, to support transmitting the response signal, the NDP manager 804 is configurable or configured to transmit a common portion of the response signal during a first period of the single NDP transmission period. In some examples, to support transmitting the response signal, the NDP manager 804 is configurable or configured to transmit a device-specific portion of the response signal during a second period of the single NDP transmission period, where the single NDP transmission period includes multiple second periods and each second period is associated with a corresponding initiating wireless device in the multiple initiating wireless devices.

In some examples, the device-specific portion includes a HE STF and at least one encrypted HE-LTF associated with the initiating wireless device. In some examples, the device-specific portion includes a HE STF and at least one unencrypted HE-LTF associated with the initiating wireless device. In some examples, the timing offset includes a LTF offset indicator.

In some examples, the response window occurs within a device-specific NDP transmission period of multiple NDP transmission periods scheduled during the sounding phase, each device-specific NDP transmission period is associated with a corresponding initiating wireless device in the multiple initiating wireless devices.

In some examples, to support transmitting the response signal, the NDP manager 804 is configurable or configured to transmit the response signal during the device-specific NDP transmission period of the initiating wireless device.

In some examples, the timing offset identifies a starting time for the device-specific NDP transmission period associated with the initiating wireless device. In some examples, the sounding signal includes a length parameter associated with the device-specific NDP transmission period. In some examples, the sounding procedure is performed in an EHT 320-megahertz channel.

In some examples, the sounding manager 802 is configurable or configured to receive a polling signal during a polling phase of the sounding procedure. In some examples, the sounding manager 802 is configurable or configured to transmit a polling response from each initiating wireless device, where the initiating wireless device is included in the multiple initiating wireless devices based on the polling response.

FIG. 9 shows a flowchart illustrating an example process 900 performable by or at a responding wireless device that supports single trigger frame use for TBR sounding modes. The operations of the process 900 may be implemented by a responding wireless device or its components as described herein. For example, the process 900 may be performed by a wireless communication device, such as the wireless communication device 800 described with reference to FIG. 8, operating as or within a wireless STA. In some examples, the process 900 may be performed by a wireless STA, such as one of the STAs 104 described with reference to FIG. 1.

In some examples, in 902, the responding wireless device may transmit a sounding signal during a sounding phase of a sounding procedure, the sounding signal indicating multiple user fields, each user field identifying a timing offset for each initiating wireless device of multiple initiating wireless devices, where the timing offset identifies a response window associated with each initiating wireless device within the sounding phase. The operations of 902 may be performed in accordance with examples as disclosed herein. In some implementations, aspects of the operations of 902 may be performed by a sounding manager 802 as described with reference to FIG. 8.

In some examples, in 904, the responding wireless device may receive a response signal from each initiating wireless device during the sounding phase, each response signal received in the response window according to the timing offset of each initiating wireless device. The operations of 904 may be performed in accordance with examples as disclosed herein. In some implementations, aspects of the operations of 904 may be performed by an NDP manager 804 as described with reference to FIG. 8.

FIG. 10 shows a flowchart illustrating an example process 1000 performable by or at an initiating wireless device that supports single trigger frame use for TBR sounding modes. The operations of the process 1000 may be implemented by an initiating wireless device or its components as described herein. For example, the process 1000 may be performed by a wireless communication device, such as the wireless communication device 800 described with reference to FIG. 8, operating as or within a wireless STA. In some examples, the process 1000 may be performed by a wireless STA, such as one of the STAs 104 described with reference to FIG. 1.

In some examples, in 1002, the initiating wireless device may receive a sounding signal during a sounding phase of a sounding procedure, the sounding signal indicating multiple user fields, each user field identifying a timing offset for each initiating wireless device of multiple initiating wireless devices, where the timing offset identifies a response window associated with the initiating wireless device within the sounding phase. The operations of 1002 may be performed in accordance with examples as disclosed herein. In some implementations, aspects of the operations of 1002 may be performed by a sounding manager 802 as described with reference to FIG. 8.

In some examples, in 1004, the initiating wireless device may transmit a response signal during the response window according to the timing offset of the initiating wireless device. The operations of 1004 may be performed in accordance with examples as disclosed herein. In some implementations, aspects of the operations of 1004 may be performed by an NDP manager 804 as described with reference to FIG. 8.

Implementation examples are described in the following numbered clauses:

Aspect 1: A method for wireless communications at a responding wireless device (e.g., an RSTA), comprising: transmitting a sounding signal during a sounding phase of a sounding procedure, the sounding signal indicating multiple user fields, each user field identifying a timing offset for each initiating wireless device of multiple initiating wireless devices, wherein the timing offset identifies a response window associated with each initiating wireless device within the sounding phase; and receiving a response signal from each initiating wireless device during the sounding phase, each response signal received in the response window according to the timing offset of each initiating wireless device.

Aspect 2: The method of aspect 1, wherein the response window occurs within a single NDP transmission period scheduled in the sounding phase.

Aspect 3: The method of aspect 2, wherein receiving the response signal comprises: receiving a common portion of the response signal from each initiating wireless device during a first period of the single NDP transmission period; and receiving a device-specific portion of the response signal from each initiating wireless devices during a second period of the single NDP transmission period, wherein the single NDP transmission period comprises multiple second periods and each second period is associated with a corresponding initiating wireless device in the multiple initiating wireless devices.

Aspect 4: The method of aspect 3, wherein the device-specific portion comprises a HE STF and at least one encrypted HE-LTF associated with the corresponding initiating wireless device.

Aspect 5: The method of any of aspects 3 through 4, wherein the device-specific portion comprises a HE STF and at least one unencrypted HE-LTF associated with the corresponding initiating wireless device.

Aspect 6: The method of any of aspects 2 through 5, wherein the timing offset comprises a LTF offset indicator.

Aspect 7: The method of any of aspects 1 through 6, wherein the response window occurs within a device-specific NDP transmission period of multiple NDP transmission periods scheduled during the sounding phase, each device-specific NDP transmission period is associated with a corresponding initiating wireless device in the multiple initiating wireless devices.

Aspect 8: The method of aspect 7, wherein receiving the response signal comprises: receiving the response signal during the device-specific NDP transmission period of the corresponding initiating wireless device.

Aspect 9: The method of any of aspects 7 through 8, wherein the timing offset identifies a starting time for the device-specific NDP transmission period associated with the corresponding initiating wireless device.

Aspect 10: The method of any of aspects 7 through 9, wherein the sounding signal comprises a length parameter associated with the device-specific NDP transmission period.

Aspect 11: The method of any of aspects 1 through 10, wherein the sounding procedure is performed in an EHT 320-megahertz channel.

Aspect 12: The method of any of aspects 1 through 11, further comprising: transmitting a polling signal during a polling phase of the sounding procedure; and receiving a polling response from each initiating wireless device, wherein the multiple initiating wireless devices are identified based at least in part on the polling response.

Aspect 13: A method for wireless communications at an initiating wireless device, comprising: receiving a sounding signal during a sounding phase of a sounding procedure, the sounding signal indicating multiple user fields, each user field identifying a timing offset for each initiating wireless device of multiple initiating wireless devices, wherein the timing offset identifies a response window associated with the initiating wireless device within the sounding phase; and transmitting a response signal during the response window according to the timing offset of the initiating wireless device.

Aspect 14: The method of aspect 13, wherein the response window occurs within a single NDP transmission period scheduled in the sounding phase.

Aspect 15: The method of aspect 14, wherein transmitting the response signal comprises: transmitting a common portion of the response signal during a first period of the single NDP transmission period; and transmitting a device-specific portion of the response signal during a second period of the single NDP transmission period, wherein the single NDP transmission period comprises multiple second periods and each second period is associated with a corresponding initiating wireless device in the multiple initiating wireless devices.

Aspect 16: The method of aspect 15, wherein the device-specific portion comprises a HE STF and at least one encrypted HE-LTF associated with the initiating wireless device.

Aspect 17: The method of any of aspects 15 through 16, wherein the device-specific portion comprises a HE STF and at least one unencrypted HE-LTF associated with the initiating wireless device.

Aspect 18: The method of any of aspects 14 through 17, wherein the timing offset comprises a LTF offset indicator.

Aspect 19: The method of any of aspects 13 through 18, wherein the response window occurs within a device-specific NDP transmission period of multiple NDP transmission periods scheduled during the sounding phase, each device-specific NDP transmission period is associated with a corresponding initiating wireless device in the multiple initiating wireless devices.

Aspect 20: The method of aspect 19, wherein transmitting the response signal comprises: transmitting the response signal during the device-specific NDP transmission period of the initiating wireless device.

Aspect 21: The method of any of aspects 19 through 20, wherein the timing offset identifies a starting time for the device-specific NDP transmission period associated with the initiating wireless device.

Aspect 22: The method of any of aspects 19 through 21, wherein the sounding signal comprises a length parameter associated with the device-specific NDP transmission period.

Aspect 23: The method of any of aspects 13 through 22, wherein the sounding procedure is performed in an EHT 320-megahertz channel.

Aspect 24: The method of any of aspects 13 through 23, further comprising: receiving a polling signal during a polling phase of the sounding procedure; and transmitting a polling response from each initiating wireless device, wherein the initiating wireless device is included in the multiple initiating wireless devices based at least in part on the polling response.

Aspect 25: A responding wireless device for wireless communications, comprising one or more memories storing processor-executable code, and one or more processors coupled with the one or more memories and individually or collectively operable to execute the code to cause the responding wireless device to perform a method of any of aspects 1 through 12.

Aspect 26: A responding wireless device for wireless communications, comprising at least one means for performing a method of any of aspects 1 through 12.

Aspect 27: A non-transitory computer-readable medium storing code for wireless communications, the code comprising instructions executable by one or more processors to perform a method of any of aspects 1 through 12.

Aspect 28: An initiating wireless device for wireless communications, comprising one or more memories storing processor-executable code, and one or more processors coupled with the one or more memories and individually or collectively operable to execute the code to cause the initiating wireless device to perform a method of any of aspects 13 through 24.

Aspect 29: An initiating wireless device for wireless communications, comprising at least one means for performing a method of any of aspects 13 through 24.

Aspect 30: A non-transitory computer-readable medium storing code for wireless communications, the code comprising instructions executable by one or more processors to perform a method of any of aspects 13 through 24.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A responding wireless device, comprising:
a processing system that includes processor circuitry and memory circuitry that stores code, the processing system configured to cause the responding wireless device to:
transmit a sounding signal during a sounding phase of a sounding procedure, the sounding signal indicating multiple user fields, each user field identifying a timing offset for each initiating wireless device of multiple initiating wireless devices, wherein the timing offset identifies a response window associated with each initiating wireless device within the sounding phase; and
receive a response signal from each initiating wireless device during the sounding phase, each response signal received in the response window according to the timing offset of each initiating wireless device.

2. The responding wireless device of claim 1, wherein the response window occurs within a single null data packet transmission period scheduled in the sounding phase.

3. The responding wireless device of claim 2, wherein, to receive the response signal, the processing system is configured to cause the responding wireless device to:
receive a common portion of the response signal from each initiating wireless device during a first period of the single null data packet transmission period; and
receive a device-specific portion of the response signal from each initiating wireless devices during a second period of the single null data packet transmission period, wherein the single null data packet transmission period comprises multiple second periods and each second period is associated with a corresponding initiating wireless device in the multiple initiating wireless devices.

4. The responding wireless device of claim 3, wherein the device-specific portion comprises a high efficiency short training field (HE STF) and at least one encrypted high efficiency long training field (HE-LTF) associated with the corresponding initiating wireless device.

5. The responding wireless device of claim 3, wherein the device-specific portion comprises a high efficiency short training field (HE STF) and at least one unencrypted high efficiency long training field (HE-LTF) associated with the corresponding initiating wireless device.

6. The responding wireless device of claim 2, wherein the timing offset comprises a long training field (LTF) offset indicator.

7. The responding wireless device of claim 1, wherein the response window occurs within a device-specific null data packet transmission period of multiple null data packet transmission periods scheduled during the sounding phase, each device-specific null data packet transmission period is associated with a corresponding initiating wireless device in the multiple initiating wireless devices.

8. The responding wireless device of claim 7, wherein, to receive the response signal, the processing system is configured to cause the responding wireless device to:
receive the response signal during the device-specific null data packet transmission period of the corresponding initiating wireless device.

9. The responding wireless device of claim 7, wherein the timing offset identifies a starting time for the device-specific null data packet transmission period associated with the corresponding initiating wireless device.

10. The responding wireless device of claim 7, wherein the sounding signal comprises a length parameter associated with the device-specific null data packet transmission period.

11. The responding wireless device of claim 1, wherein the sounding procedure is performed in an extremely high throughput (EHT) 320-megahertz channel.

12. The responding wireless device of claim 1, wherein the processing system is further configured to cause the responding wireless device to:
transmit a polling signal during a polling phase of the sounding procedure; and
receive a polling response from each initiating wireless device, wherein the multiple initiating wireless devices are identified based at least in part on the polling response.

13. An initiating wireless device, comprising:
a processing system that includes processor circuitry and memory circuitry that stores code, the processing system configured to cause the initiating wireless device to:
receive a sounding signal during a sounding phase of a sounding procedure, the sounding signal indicating multiple user fields, each user field identifying a timing offset for each initiating wireless device of multiple initiating wireless devices, wherein the timing offset identifies a response window associated with the initiating wireless device within the sounding phase; and
transmit a response signal during the response window according to the timing offset of the initiating wireless device.

14. The initiating wireless device of claim 13, wherein the response window occurs within a single null data packet transmission period scheduled in the sounding phase.

15. The initiating wireless device of claim 14, wherein, to transmit the response signal, the processing system is configured to cause the initiating wireless device to:
transmit a common portion of the response signal during a first period of the single null data packet transmission period; and
transmit a device-specific portion of the response signal during a second period of the single null data packet transmission period, wherein the single null data packet transmission period comprises multiple second periods and each second period is associated with a corresponding initiating wireless device in the multiple initiating wireless devices.

16. The initiating wireless device of claim 15, wherein the device-specific portion comprises a high efficiency short training field (HE STF) and at least one encrypted high efficiency long training field (HE-LTF) associated with the initiating wireless device.

17. The initiating wireless device of claim 15, wherein the device-specific portion comprises a high efficiency short training field (HE STF) and at least one unencrypted high efficiency long training field (HE-LTF) associated with the initiating wireless device.

18. The initiating wireless device of claim 14, wherein the timing offset comprises a long training field (LTF) offset indicator.

19. The initiating wireless device of claim 13, wherein the response window occurs within a device-specific null data packet transmission period of multiple null data packet transmission periods scheduled during the sounding phase, each device-specific null data packet transmission period is associated with a corresponding initiating wireless device in the multiple initiating wireless devices.

20. The initiating wireless device of claim 19, wherein, to transmit the response signal, the processing system is configured to cause the initiating wireless device to:
transmit the response signal during the device-specific null data packet transmission period of the initiating wireless device.

21. The initiating wireless device of claim 19, wherein the timing offset identifies a starting time for the device-specific null data packet transmission period associated with the initiating wireless device.

22. The initiating wireless device of claim 19, wherein the sounding signal comprises a length parameter associated with the device-specific null data packet transmission period.

23. The initiating wireless device of claim 13, wherein the sounding procedure is performed in an extremely high throughput (EHT) 320-megahertz channel.

24. The initiating wireless device of claim 13, wherein the processing system is further configured to cause the initiating wireless device to:
receive a polling signal during a polling phase of the sounding procedure; and
transmit a polling response from each initiating wireless device, wherein the initiating wireless device is included in the multiple initiating wireless devices based at least in part on the polling response.

25. A method for wireless communications at a responding wireless device, comprising:
transmitting a sounding signal during a sounding phase of a sounding procedure, the sounding signal indicating multiple user fields, each user field identifying a timing offset for each initiating wireless device of multiple initiating wireless devices, wherein the timing offset identifies a response window associated with each initiating wireless device within the sounding phase; and
receiving a response signal from each initiating wireless device during the sounding phase, each response signal received in the response window according to the timing offset of each initiating wireless device.

26. The method of claim 25, wherein the response window occurs within a single null data packet transmission period scheduled in the sounding phase.

27. The method of claim 26, wherein receiving the response signal comprises:
receiving a common portion of the response signal from each initiating wireless device during a first period of the single null data packet transmission period; and
receiving a device-specific portion of the response signal from each initiating wireless devices during a second period of the single null data packet transmission period, wherein the single null data packet transmission period comprises multiple second periods and each second period is associated with a corresponding initiating wireless device in the multiple initiating wireless devices.

28. The method of claim 27, wherein the device-specific portion comprises a high efficiency short training field (HE STF) and at least one encrypted high efficiency long training field (HE-LTF) associated with the corresponding initiating wireless device.

29. The method of claim 27, wherein the device-specific portion comprises a high efficiency short training field (HE STF) and at least one unencrypted high efficiency long training field (HE-LTF) associated with the corresponding initiating wireless device.

30. A method for wireless communications at an initiating wireless device, comprising:
receiving a sounding signal during a sounding phase of a sounding procedure, the sounding signal indicating multiple user fields, each user field identifying a timing offset for each initiating wireless device of multiple initiating wireless devices, wherein the timing offset identifies a response window associated with the initiating wireless device within the sounding phase; and
transmitting a response signal during the response window according to the timing offset of the initiating wireless device.
